(19) United States
(12) Patent Application Publication
(10) Pub. No.: US 2022/0288839 A1
(43) Pub. Date: Sep. 15, 2022

(54) LAMINATION WORKPIECE MOLDING DEVICE

(71) Applicant: HONDA MOTOR CO., LTD., Tokyo (JP)

(72) Inventors: Hiroaki Iwanishi, Tochigi (JP); Akira Taguchi, Tochigi (JP)

(21) Appl. No.: 17/637,501

(22) PCT Filed: Mar. 30, 2020
(86) PCT No.: PCT/JP2020/014573

§ 371 Date: Feb. 23, 2022

(30) Foreign Application Priority Data
Aug. 29, 2019 (JP) 2019-157275

(51) Int. Cl. B29C 51/36; B29C 51/10

(52) U.S. Cl. CPC B29C 51/365; B29C 51/10

(57) ABSTRACT

A lamination workpiece molding device 1 includes a first mold 20 and a second mold 30. A second mold 30 includes a through-hole 32 that extends to be opened and positioned at a peripheral edge of a workpiece body 42, the through-hole 32 is connected to a first suction device 51 that sucks a sheet material 44, the lamination workpiece molding device 1 includes a control unit that sets suction forces of the first suction device 51 and a second suction device 52, the second mold 30 includes a box body 81 communicating with the through-hole 32, the first suction device 51 communicates with the through-hole 32 via the box body 81, and the box body 81 is configured to be able to prevent movement of gas between inside and outside of the box body 81 excluding a connection portion with the through-hole 32 and the first suction device 51.

### TECHNICAL FIELD

The present invention relates to a lamination workpiece molding device.

### BACKGROUND ART

Conventionally, a lamination workpiece molding device that molds a lamination workpiece, which includes a workpiece body and a sheet material laminated on the workpiece body, by using a first mold that sucks and holds the workpiece body has been known (see, for example, JP 7-24909 A).

In JP 7-24909 A, a clearance recess portion formed in a central portion of a workpiece body is closed by a shutter in order to prevent a sheet material from being pulled into and broken by the clearance recess portion.

Further, since the degree of freedom in layout of the workpiece body is limited when the shutter covering the clearance recess portion is provided, there is also known what is provided with a suction device that is positioned in the clearance recess portion formed in the central portion of the workpiece body and sucks the sheet material in a direction away from the workpiece body (see, for example, JP 2000-218688 A).

### CITATION LIST

### Patent Literature

Patent Literature 1: JP 7-24909 A

Patent Literature 2: JP 2000-218688 A

### SUMMARY OF INVENTION

### Technical Problem

In a lamination workpiece molding device of JP 7-24909 A, in a case where a second mold having, on an inner surface, a pattern that can be transferred to a surface of a sheet material is used, it is conceivable that fluid such as air is ejected from the second mold in such a manner as to make it easier for the sheet material to be separated from the second mold when a first mold that sucks a workpiece body and the second mold are made to overlap with each other and the sheet material is attached to the workpiece body after the sheet material is sucked by the second mold and the pattern is transferred thereto.

In this case, unlike JP 7-24909 A, it is not possible to provide a suction device that is placed in a clearance recess portion in a central portion of the workpiece body and that sucks the sheet material in a direction away from the workpiece body. Thus, in order to improve the degree of freedom in layout of the workpiece body, it is conceivable to arrange an insert in the clearance recess portion.

Further, it is conceivable to provide a shutter device at a peripheral edge of the workpiece body that does not affect the degree of freedom in layout of the workpiece body to prevent the sheet material from sticking to a place where the sheet material is not to be stuck at the peripheral edge of the workpiece body.

However, when the shutter device is provided at the peripheral edge of the workpiece body, there is a problem that since the sheet material is gripped by a clamp arranged outside the shutter device, it is necessary to prepare a sheet material that is large because of the shutter device, and the manufacturing cost of the lamination workpiece cannot be suppressed.

Further, the shutter device has a complicated structure, the shutter device needs to be installed in a plurality of places, the mold manufacturing cost cannot be suppressed, and further the maintenance of the shutter device requires labor and the maintainability is low.

In view of the above, it is an object of the present invention to provide a lamination workpiece molding device that can suppress the manufacturing costs of the lamination workpiece and the mold and improve the maintainability.

### Solution to Problem

[1] In order to achieve the above object, the present invention is

a lamination workpiece molding device (for example, a lamination workpiece molding device 1 of an embodiment. The same applies hereinafter) including:

a first mold (for example, a first mold 20 of the embodiment. The same applies hereinafter) configured to suck and hold a workpiece body (for example, a workpiece body 42 of the embodiment. The same applies hereinafter); and

a second mold (for example, a second mold 30 of the embodiment. The same applies hereinafter) configured to have on an inner surface a pattern (for example, a pattern of the embodiment. The same applies hereinafter) that can be transferred to a surface of a sheet material laminated on the workpiece body and press the sheet material against the workpiece body, in which

the second mold includes a through-hole (for example, a through-hole 32 of the embodiment. The same applies hereinafter) that extends to be opened and positioned at a peripheral edge of the workpiece body,

the through-hole is connected to a first suction device (for example, a first suction device 51 of the embodiment. The same applies hereinafter) that sucks the sheet material,

the first mold includes a suction hole (for example, a suction hole 22 of the embodiment. The same applies hereinafter) for sucking the workpiece body,

the suction hole is connected to a second suction device (for example, a second suction device 52 of the embodiment. The same applies hereinafter),

the lamination workpiece molding device includes a control unit (for example, a control unit 61 of the embodiment. The same applies hereinafter) that sets suction forces of the first suction device and the second suction device,

the second mold includes a box body (for example, a box body 81 of the embodiment. The same applies hereinafter) communicating with the through-hole,

the first suction device communicates with the through-hole via the box body, and

the box body is configured to be able to prevent movement of gas between inside and outside of the box body excluding a connection portion with the through-hole and the first suction device.

According to the present invention, the sheet material at the peripheral edge of the workpiece body is sucked by the first suction device and drawn toward the second mold side so as to be spaced from the first mold. Therefore, it is not necessary to dispose the shutter device at the peripheral edge of the workpiece body. Thus, the lamination workpiece molding device can be provided in which the lamination workpiece can be molded using a sheet material that is small because the shutter device can be omitted and the manufacturing cost of the lamination workpiece can be suppressed. Further, since the structure of the mold can be simplified as compared with the case where the shutter device is provided, the mold manufacturing cost can be suppressed, and the maintainability can also be improved.

Further, since the second mold has a porous structure, in a case where the box body is not provided, even when suction is performed through the through-hole using the first suction device, the gas is sucked from an unintended place through the second mold having the porous structure, and there is a possibility that a desired suction force cannot be obtained from the through-hole. Here, in order to prevent suction of the gas from an unintended place, it is conceivable to fill a hole based on the porous structure in a connection portion connecting the through-hole and the first suction device by plating treatment, resin application, or the like. However, the plating treatment and the resin application are troublesome, and the manufacturing cost of the lamination workpiece molding device increases.

Therefore, in the present invention, by providing the box body in the second mold, which is a connection passage between the through-hole and the first suction device, it is possible to prevent the movement of the gas between the inside and the outside of the box body in the portion excluding the through-hole and the connection port of the first suction device without performing the plating treatment even in the second mold having the porous structure, and it is possible to obtain a desired suction force from the through-hole.
[2] Further, in the present invention,

the box body can include an opening that opens toward a cavity side of the second mold,

the opening can be covered with a porous electrocast body (for example, a lid portion 82 of the embodiment. The same applies hereinafter), and

the through-hole can be provided in the porous electrocast body.

### BRIEF DESCRIPTION OF DRAWINGS

FIG. 1 is an explanatory view schematically illustrating an embodiment of a lamination workpiece molding device of the present invention.

FIG. 2 is an explanatory view illustrating a first mold and a workpiece body of the present embodiment.

FIG. 3 is an explanatory view illustrating a through-hole of the present embodiment in an enlarged manner.

FIG. 4 is an explanatory view illustrating a part of a manufacturing process of a second mold of the present embodiment.

FIG. 5 is an explanatory view illustrating a part of the manufacturing process of the second mold of the present embodiment.

FIG. 6 is an explanatory view illustrating a part of the manufacturing process of the second mold of the present embodiment.

FIG. 7 is an explanatory view schematically illustrating a shutter device as a comparative example.

### DESCRIPTION OF EMBODIMENTS

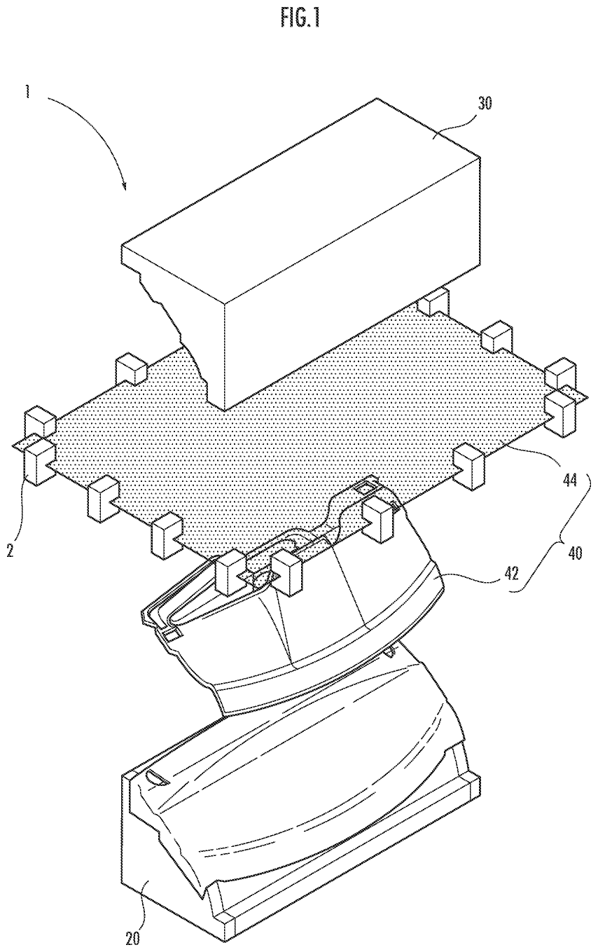

An embodiment of the lamination workpiece molding device and the lamination workpiece molding method of the present invention will be described with reference to the drawings. Referring to FIG. 1, a lamination workpiece molding device 1 of the present embodiment includes a first mold 20, which is a porous electrocast body, and a second mold 30, which is a porous electrocast body. A lamination workpiece 40 such as an instrument panel molded by the lamination workpiece molding device 1 includes a workpiece body 42 and a sheet material 44 laminated on the workpiece body 42.

The lamination workpiece molding device 1 includes a plurality of clamps 2 for gripping the peripheral edge of the sheet material 44. The clamp 2 is movably supported by a support device (not illustrated) provided outside the peripheral edge of the first mold 20.

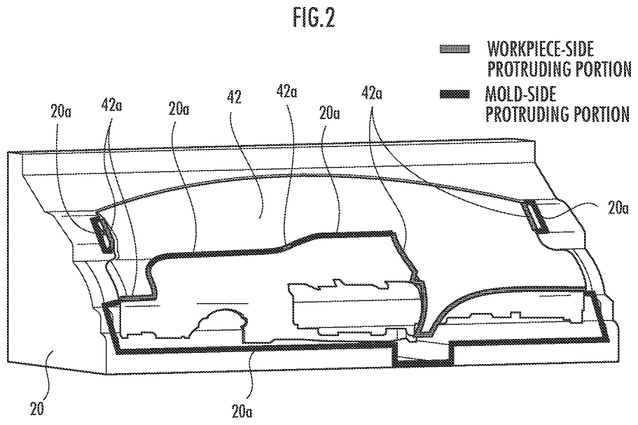

FIG. 2 illustrates a state in which the workpiece body 42 is placed on the first mold 20.

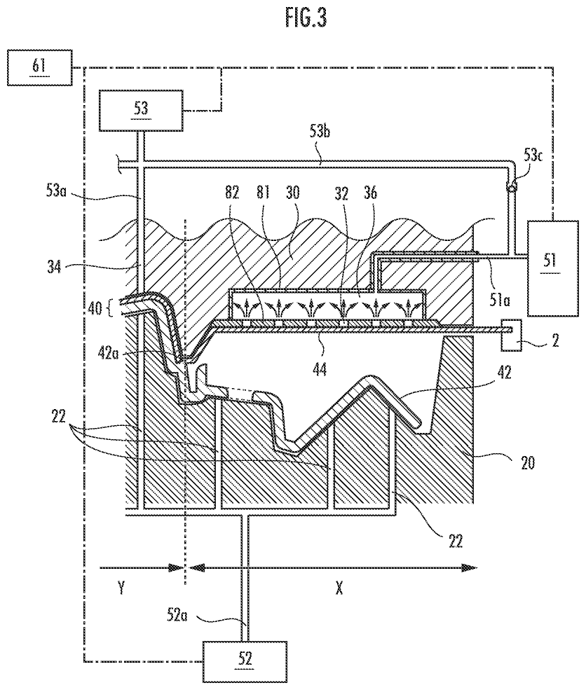

As illustrated in FIG. 3, a plurality of suction holes 22 opened to a placement surface on which the workpiece body 42 is placed is provided in the first mold 20. The suction hole 22 may be formed by a pore or an open pore of the first mold 20, which is a porous electrocast body. On the inner surface of the second mold 30, a pattern such as embossing or satin to be transferred to the surface of the sheet material 44 is formed.

A box body 81 having a bottomed rectangular cylindrical shape is embedded in the second mold 30 so as to be embedded in a recess portion 36 so as to be opened at the position of the peripheral edge of the workpiece body 42 when the second mold 30 is overlapped with the first mold 20 with the workpiece body 42 and the sheet material 44 interposed therebetween. A first connection pipe 51a is connected to a bottom plate (a plate located above in FIG. 3) of the box body 81 by welding.

A plurality of through-holes 32 penetrating in such a manner as to be opened to the position of the peripheral edge of the workpiece body 42 when the second mold 30 is overlapped with the first mold 20 with the workpiece body 42 and the sheet material 44 interposed therebetween is provided in the second mold 30. The through-hole 32 of the present embodiment is formed by a pore or an open pore in a lid portion 82, which is a porous electrocast body, provided so as to cover the cavity-side opening of the box body 81 embedded in the recess portion 36. Note that the through-hole of the present invention is not limited to a pore or an open pore, and, for example, a plate may be provided so as to cover the opening of the recess portion 36 formed on the inner surface of the second mold 30, and the through-hole may be formed by a hole formed in the plate.

Further, the second mold 30 includes a plurality of ejection holes 34 extending to be opened at the position of a central portion of the workpiece body 42, which is a portion excluding the peripheral edge of the workpiece body 42. The ejection hole 34 may be formed by a pore or an open pore in the second mold 30, which is a porous electrocast body.

The through-holes 32 of the lid portion 82 are connected to a first suction device 51 for sucking the sheet material 44 via the first connection pipe 51a via the box body 81. A second suction device 52 for sucking the workpiece body 42 is connected to the suction holes 22 via a second connection pipe 52a. The ejection holes 34 are connected to a gas supply device 53 capable of supplying a gas such as air via a third connection pipe 53a.

The first connection pipe 51a and the third connection pipe 53a are connected to a bypass path 53b. The bypass path 53b is provided with a check valve 53c. The check valve 53c is configured to allow the movement of the gas from the first connection pipe 51a to the third connection pipe 53a and prevent the movement of the gas from the third connection pipe 53a to the first connection pipe 51a.

Further, referring to FIG. 2, in the first mold 20 and the workpiece body 42, a mold-side protruding portion 20a protruding toward the second mold 30 from the first mold 20 and a workpiece-side protruding portion 42a protruding toward the second mold 30 from the workpiece body 42 are respectively provided in such a manner as to surround the plurality of through-holes 32 and to extend along an outer edge of a bonded region of the sheet material 44.

Here, assuming that the mold-side protruding portion 20a and the workpiece-side protruding portion 42a are not provided, when the sheet material 44 is separated from the second mold 30 by supplying the gas to the surface of the sheet material 44 from the gas supply device 53 through the ejection holes 34 in the bonding process of bonding the sheet material 44 to the workpiece body 42, when the gas supplied to the surface of the sheet material 44 flows directly into the through-holes 32 and is sucked by the first suction device 51, the sheet material 44 suction performance by the first suction device 51 deteriorates.

Therefore, in the present embodiment, as described above, when the mold-side protruding portion 20a and the workpiece-side protruding portion 42a are provided so as to surround the through-holes 32, it is possible to suppress or prevent the gas supplied from the gas supply device 53 to the surface of the sheet material 44 from flowing into the through-holes 32 from between the second mold 30 and the sheet material 44, and it is possible to suppress or prevent the deterioration of the sheet material 44 suction performance by the first suction device 51 in a direction of the second mold 30. Note that, instead of the mold-side protruding portion 20a and the workpiece-side protruding portion 42a, the mold-side protruding portion may be provided on the second mold 30.

The lamination workpiece molding device 1 includes a control unit 61 that controls the first suction device 51, the second suction device 52, and the gas supply device 53. The control unit 61 is an electronic control unit including a CPU, a memory, and the like, and controls the first suction device 51, the second suction device 52, and the gas supply device 53 by executing a control program held in a storage unit such as the memory by using the CPU and transmitting an instruction signal.

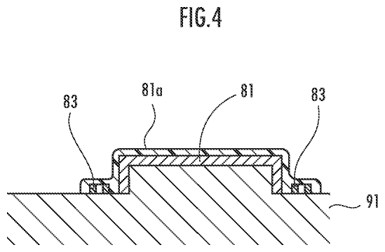

As illustrated in FIG. 4, the second mold 30 and the box body 81 are manufactured using a dedicated first electrocasting base mold 91. As illustrated in FIG. 4, first, the box body 81 is placed on the first electrocasting base mold 91 and a plurality of nuts 83 is placed at positions around the box body 81. Pins for positioning the nuts 83 are erected on the first electrocasting base mold 91. In FIG. 4, only a part of the first electrocasting base mold 91 on which the box body 81 is placed is illustrated.

Then, the box body 81 and the nuts 83 are covered with a plating layer 81a by electrocasting to complete the box body 81. The box body 81 of the present embodiment includes the nuts 83 and the plating layer 81a.

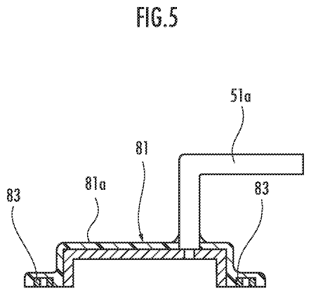

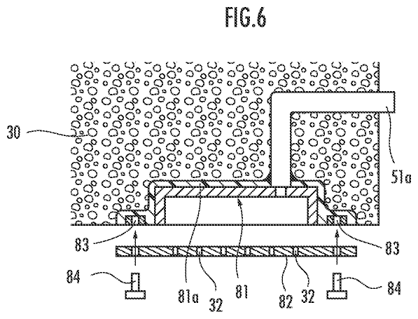

After the box body 81 is completed, as illustrated in FIG. 5, the box body 81 is once detached from the first electrocasting base mold 91 a through-hole is formed in the bottom plate of the box body 81, and the first connection pipe 51a is connected to the box body 81 by welding. Then, as illustrated in FIG. 6, the box body 81 to which the first connection pipe 51a is connected is placed again on the first electrocasting base mold 91, and the second mold 30 in which the box body 81 is fitted into the recess portion 36 is molded by electrocasting. The outer circumference of the second mold 30 is adjusted by machining after molding by electrocasting.

When metal ions in an electrolyte solution are supplied to the inside of the first connection pipe 51a at the time of molding the second mold 30 by electrocasting, there is a possibility that an electrocast body is molded and clogs the first connection pipe 51a. Therefore, an outer end of the first connection pipe 51a is capped so that metal ions in the electrolytic solution are not supplied.

Next, as illustrated in FIG. 6, the lid portion 82 that, closes the opening of the box body 81 is screwed and fixed to the nuts 83 with bolts 84.

Next, the lamination workpiece molding method using the lamination workpiece molding device 1 will be described.

First, the first mold 20 and the second mold 30 are brought into an open state, and the workpiece body 42 is placed on the first mold 20. Then, the sheet material 44 gripped by the clamps 2 is arranged between the workpiece body 42 and the second mold 30. Then, the first mold 20 and the second mold 30 are brought closer to each other into a closed state.

Next, the control unit 61 causes the first suction device 51 to suck the sheet material 44 via the through-holes 32 and the ejection holes 34 and stick the sheet material 44 to the inner surface of the second mold 30. Thus, the pattern formed on the inner surface of the second mold 30 can be transferred to the surface of the sheet material 44 (transfer process).

Next, in a state where an adhesive is applied to the workpiece body 42 or the sheet material 44, the sheet material 44 is pressed against the workpiece body 42 and is bonded by suction force of the second suction device 52 (bonding process).

Here, the sheet material 44 is not bonded to the entire surface of the workpiece body 42, but is bonded only to a portion to be exposed when an automobile or the like is assembled, and is not bonded, unbonded, to a portion such as the peripheral edge to be hidden by other components during assembly to prevent assembly failure, and only the bonded portion is left and the non-bonded portion is cut and discarded.

Then, in the bonding process, the control unit 61 supplies the gas between the sheet material 44 and the second mold 30 with the gas supply device 53 via the ejection holes 34 so that the sheet material 44 is separated from the second mold 30.

Further, the control unit 61 sucks a portion of the sheet material 44 not bonded to the workpiece body 42 to the second mold 30 via the through-holes 32 with the first suction device 51.

Here, the control unit 61 sets suction forces of the first suction device 51 and the second suction device 52 in such a manner that the suction force to suck the sheet material 44 from the through-holes 32 becomes stronger than the suction force to suck the workpiece body 42 from the suction holes 22 as indicated by a non-bonded region X in FIG. 3. By setting the suction threes in this manner, the sheet material 44 of the unbonded portion can be appropriately drawn to the second mold 30.

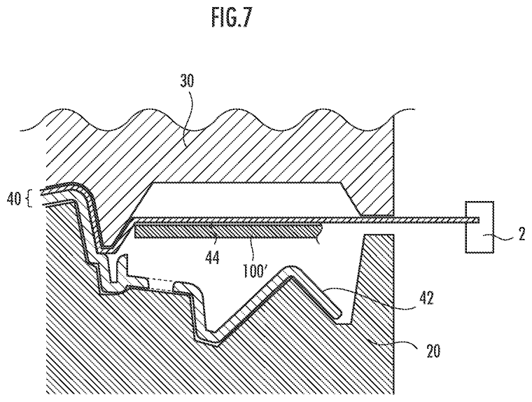

Thus, since the unbonded portion placed at the peripheral edge of the workpiece body 42 is sucked to be drawn to the second mold 30 side by the first suction device 51 via the through-holes 32, it is not necessary to provide a shutter device 100′ that prevents bonding of the sheet material 44 at the peripheral edge of the workpiece body 42 unlike a comparative example illustrated in FIG. 7. Therefore, it is not necessary to arrange the clamps outside the shutter device 100′ so as to avoid the shutter device 100′ or prepare a wide sheet material 44, and the amount of the waste part of the sheet material 44 can be reduced and the manufacturing cost for the lamination workpiece 40 can be suppressed.

Further, assuming that the mold-side protruding portion 20a and the workpiece-side protruding portion 42a are not provided, when the sheet material 44 is separated from the second mold 30 by supplying the gas to the surface of the sheet material 44 from the gas supply device 53 through the ejection holes 34 in the bonding process of bonding the sheet material 44 to the workpiece body 42, when the gas supplied to the surface of the sheet material 44 flows directly into the through-holes 32 and is sucked by the first suction device 51, the sheet material 44 suction performance by the first suction device 51 deteriorates.

Therefore, in the present embodiment, as described above, when the mold-side protruding portion 20a and the workpiece-side protruding portion 42a are provided so as to surround the through-holes 32, it is possible to suppress or prevent the gas supplied from the gas supply device 53 to the surface of the sheet material 44 from flowing into the through-holes 32, and it is possible to suppress or prevent the deterioration of the sheet material 44 suction performance by the first suction device 51. Note that, instead of the mold-side protruding portion 20a and the workpiece-side protruding portion 42a, the mold-side protruding portion may be provided on the second mold 30.

Further, since the second mold 30 has a porous structure, if the box body 81 is not provided, even when suction is performed through the through-holes 32 using the first suction device 51, the gas is sucked from an unintended place (i.e., a portion other than the through-holes 32) through the second mold 30 having the porous structure, and there is a possibility that a desired suction force cannot be obtained from the through-holes 32. Here, in order to prevent suction of the gas from an unintended place, it is conceivable to fill a hole based on the porous structure on the peripheral surface of the recess portion 36, which is a connection portion connecting the through-holes 32 and the first suction device 51, by plating treatment, resin application, or the like. However, the plating treatment and the resin application are troublesome, and the manufacturing cost of the lamination workpiece molding device increases.

Therefore, in the present embodiment, by fitting and attaching the box body 81 into the recess portion 36 of the second mold 30, even in the case of the second mold 30 having a porous structure, it is possible to prevent the movement of the gas between the inside and the outside of the box body 81 in the portion excluding the through-holes 32 and the connection port connected via the first connection pipe 51a of the first suction device 51 without performing plating treatment or the like, and it is possible to obtain a desired suction force from the through-holes 32.

Further, the present embodiment describes that the bypass path 53b that bypasses the first connection pipe 51a and the third connection pipe 53a is provided, and the check valve 53c is provided in the bypass path 53b. However, the present invention is not limited to this, and, for example, an electromagnetic valve may be provided in the bypass path instead of the check valve 53c, and the control unit may control the electromagnetic valve.

### REFERENCE SIGNS LIST

1 lamination workpiece molding device
2 clamp
20 first mold
20a mold-side protruding portion
22 suction hole
30 second mold
32 through-hole
34 ejection hole
36 recess portion
40 lamination workpiece
42 workpiece body
42a workpiece-side protruding portion
44 sheet material
51 first suction device
51a first connection pipe
52 second suction device
52a second connection pipe
53 gas supply device
53a third connection pipe
53b bypass path
53c check valve
55 third suction device
55a fourth connection pipe
61 control unit
81 box body
81a plating layer
82 lid portion
83 nut
84 bolt
91 first electrocasting base mold
100′ shutter device
X non-bonded region
Y bonded region

1. A lamination workpiece molding device comprising:
a first mold configured to suck and hold a workpiece body; and
a second mold configured to have on an inner surface a pattern that can be transferred to a surface of a sheet material laminated on the workpiece body and press the sheet material against the workpiece body, wherein
the second mold includes a through-hole that extends to be opened and positioned at a peripheral edge of the workpiece body,
the through-hole is connected to a first suction device that sucks the sheet material,
the, first mold includes a suction hole for sucking the workpiece body,
the suction hole is connected to a second suction device,
the lamination workpiece molding device includes a control that sets suction forces of the first suction device and the second suction device,
the second mold includes a box body communicating with the through-hole,
the first suction device communicates with the through-hole via the box body, and
the box body is configured to be able to prevent movement of gas between inside and outside of the box body excluding a connection portion with the through-hole and the first suction device.

2. The lamination workpiece molding device according to claim 1, wherein
the box body includes an opening that opens toward a cavity side of the second mold,
the opening is covered with a porous electrocast body, and
the through-hole is provided in the porous electrocast body.
